(19) United States
(12) Patent Application Publication
(10) Pub. No.: US 2013/0166582 A1
(43) Pub. Date: Jun. 27, 2013

(54) OPERATION OF A USER INTERFACE

(71) Applicant: INTERNATIONAL BUSINESS MACHINES CORPORATION, Armonk, NY (US)

(72) Inventors: David Bell, Southampton (GB); Philip Norton, Eastleigh (GB)

(73) Assignee: INTERNATIONAL BUSINESS MACHINES CORPORATION, Armonk, NY (US)

(21) Appl. No.: 13/724,356

(22) Filed: Dec. 21, 2012

(30) Foreign Application Priority Data
Dec. 22, 2011 (GB) 1122079.5

(51) Int. Cl. G06F 17/30

(52) U.S. Cl. CPC G06F 17/30557
USPC 707/758

(57) ABSTRACT

Embodiments relate to a user interface with an aspect having a method for operating a user interface including detecting a sequence of actions with respect to the user interface and accessing a database having a plurality of pattern keys, wherein each of the pattern keys define a sequence of actions with respect to the user interface and a specific end result for the sequence of actions. The method also includes matching the detected sequence of actions with respect to the user interface and responsive to one of the pattern keys in the database and performing a predefined action in the user interface in relation to the specific end result of a matched pattern key.

### PRIORITY

The present application claims priority to the GB application number 1122079.5 filed Dec. 22, 2011 and all benefits accruing there from under U.S.C. §119, the contents of which is incorporated herein in its entirety.

### BACKGROUND

The present disclosure relates generally to computer interfaces and more particularly to techniques relating to the operation of user interfaces.

Every device, particularly digital devices, is designed to provide communication with a user. This communication is enabled often by a user interface. User interfaces can be simple or sophisticated in nature. In simple devices, a user interface may only constitute a plurality of buttons or the like to receive user inputs and a manner, such as lights, to provide or indicate output to the user. In more sophisticated devices, user interfaces may be very complex and can include display devices that are provided to deliver feedback to a user. For example, in modern smartphones it is common to provide a touch screen that serves both as a display device and as a means to receive an input from a user. Similarly, desktop computing systems provide a display device for output and a keyboard and a mouse for input. These commonly use a graphical user interface with which a user interacts in order to control the functions of the desktop computer.

The evolving technology has increased the level of complexity and infrastructure of user interfaces. Recent user interfaces include many functions that can be carried out in parallel by the devices.

### BRIEF SUMMARY

Embodiments include a method, system, and computer program product relating to a user interface. The method includes detecting a sequence of actions with respect to the user interface and accessing a database having a plurality of pattern keys, wherein each of the pattern keys define a sequence of actions with respect to the user interface and a specific end result for the sequence of actions. The method also includes matching the detected sequence of actions with respect to the user interface and responsive to one of the pattern keys in the database and performing a predefined action in the user interface in relation to the specific end result of a matched pattern key.

Additional features and advantages are realized through the techniques of the present disclosure. Other embodiments and aspects of the disclosure are described in detail herein. For a better understanding of the disclosure with the advantages and the features, refer to the description and to the drawings.

BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the disclosure are apparent from the following detailed description taken in conjunction with the accompanying drawings in which:

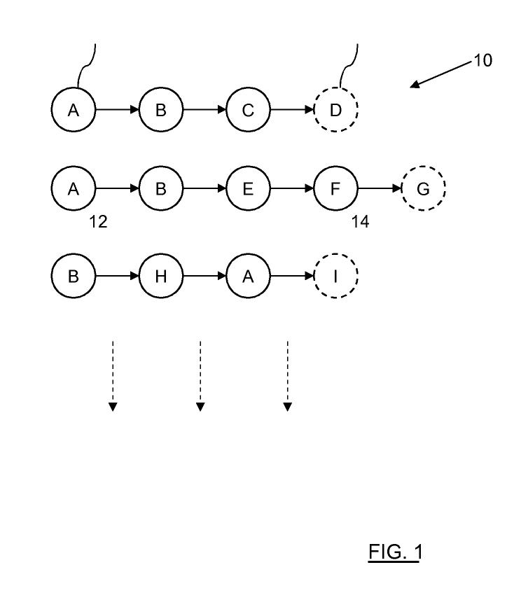

FIG. 1 is an illustration of a schematic diagram having a set of pattern keys in accordance to one embodiment;

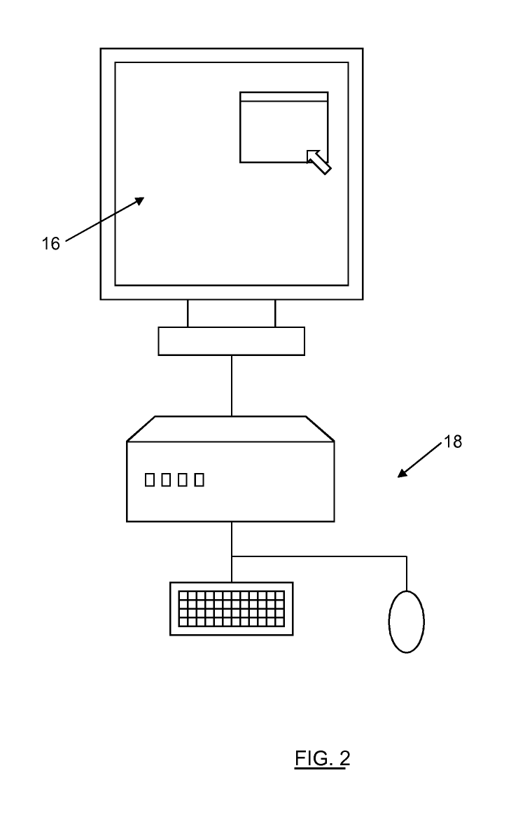

FIG. 2 is an illustration of a schematic diagram of a computer in accordance to one embodiment;

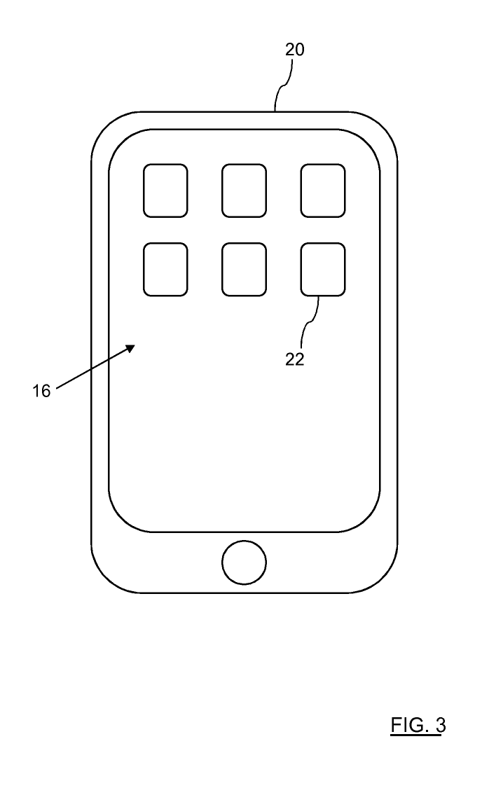

FIG. 3 is an illustration of schematic diagram of an exemplary embodiment depicting a smartphone;

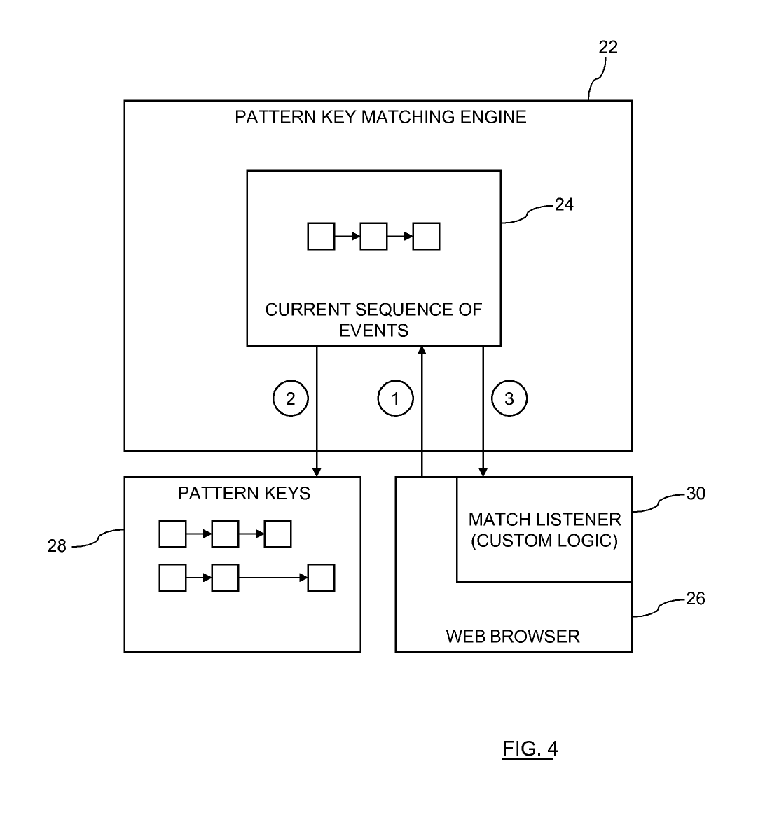

FIG. 4 is an illustration of a schematic diagram of some of the components of the computer of embodiment of FIG. 2 in accordance to one embodiment;

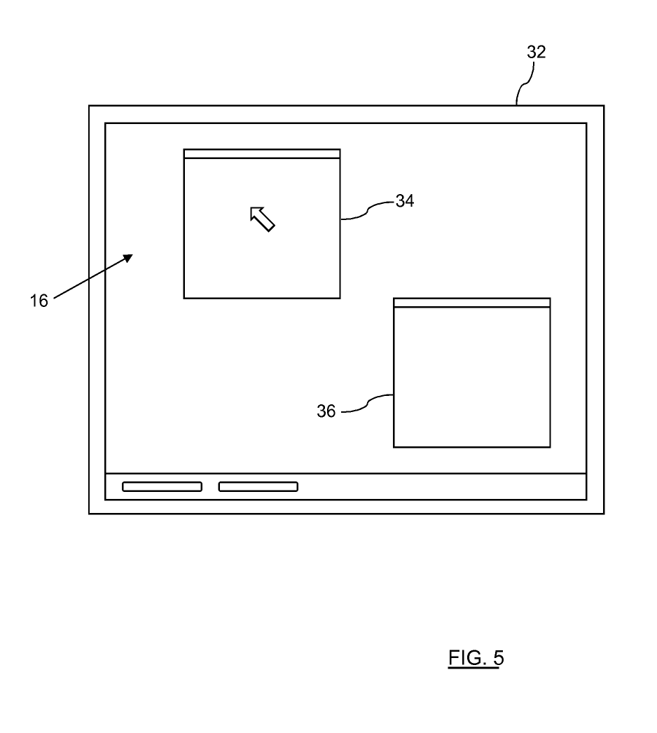

FIG. 5 is an illustration of a schematic diagram of a display device in accordance to one embodiment; and

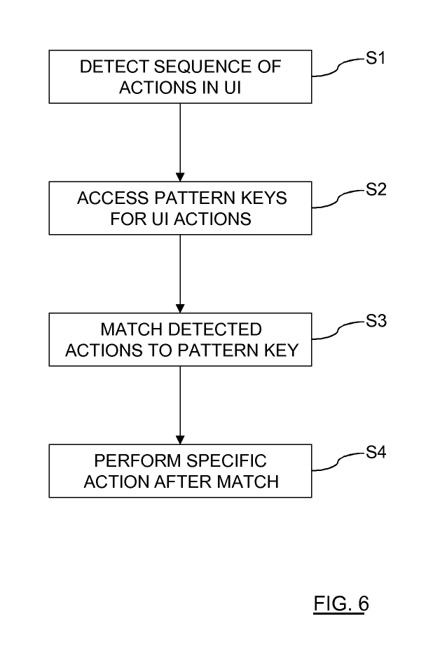

FIG. 6 is an illustration of a flowchart of a method of operating a user interface in accordance to one embodiment.

### DETAILED DESCRIPTION

FIG. 1 is an illustration depicting a series of pattern keys 10 in accordance to one embodiment. Each pattern key 10 defines a sequence of actions 12 with respect to a user interface and also a specific end result 14 for the sequence of actions 12. The first pattern key 10 defines the sequence of actions A→B→C which lead to the end result of D. The pattern key 10 defines an end result 14 that is likely to occur with a high probability given the previous sequence of actions 12. If the user is detected to have performed the actions A, B and C in that order, then it is assumed that there is a high likelihood that the user is going to perform the action D either immediately following action C or very shortly afterwards (with only a small number of intervening actions).

A simple example of a pattern key 10 might be a user who, when they have free time, always checks their work calendar, email, personal email, RSS feeds, news website and their favorite shopping website, in that order. A pattern key 10 could predict that the user will go to the shopping website if they have already been to the others. Another pattern key 10 might also predict they will go to the news website if they have already performed the previous ones, for example. The actions that the user takes within a user interface to access the various applications or components within applications are logged and can be compared against the pattern keys 10.

The pattern keys 10 can be global in the sense that they apply to all users of a device such as a desktop computer or smartphone or they can be specific to a known user based on their prior history of the use of the device. Very little processing is required to monitor the user's actions to compare their actions against the actions 12 defined within the pattern keys 10. This means that the pattern keys 10 can be used on low specification devices or indeed embedded within webpages or web applications. The correct generation of the pattern keys 10 is assumed to have taken place already and the use of them, once created, is not a complex task.

To create the pattern keys 10 in the first place, the actions of users of would be captured and stored. In a computing environment, this would include things such as, but not limited to, websites visited, links clicked on, navigation through menus, bookmarks clicked on, other applications used and so on. Each of these actions would be stored as a node in a large neural net, with the user's actions making a path between certain nodes. Once a large amount of data has been captured for an individual, or from individuals generally for global pattern keys 10, the neural net of data would be processed (using known techniques) to produce the pattern keys 10.

The pattern keys 10 would contain a number of nodes 12 and a destination node 14, where it can be accurately predicted that if the nodes 12 are all visited by the user, it can be accurately predicted that the user will visit the destination node 14, either immediately or very shortly afterwards. This prediction could then be used for a wide range of things, such as automatic loading and caching, or the opening of the destination node web address, management of dynamic shortcuts and/or bookmarks and also for advertising purposes (if it is known where a user is going next, companies can provide adverts in earlier pages/applications). FIG. 2 shows a graphical user interface 16 on a computer 18.

The use of pattern keys 10, in this embodiment, could be used within the user interface 16 of specific applications, many of which are web based. For example, if a user normally logs into an application server and often navigates straight to a particular security page, after predicting that this is the likely target, the user interface could provide a link to the final page, or provide the settings shallower in the navigation tree. This has a big advantage over a simple list of shortcuts as it is dynamic. Each user will see links or data that match their particular actions on that particular occasion, and without any performance overhead, thanks to the lightweight nature of using pattern keys for prediction.

FIG. 3 is an illustration of an example depicting a different device. In this case the device used is a smartphone 20 with the understanding that as can be appreciated by those skilled in the art, alternate devices can be used. The smartphone 20 has a touchscreen 16 that acts as the user's primary user interface. Icons 22 are presented on the user interface 16 and the user can launch applications by tapping on the touchscreen 16 at the location of an icon 22. The user can then interact with the launched application. In order to generate pattern keys, a data capture phase is necessary in which all of a user's individual actions are recorded and stored as nodes in a neural net. A path is drawn between all of the actions showing the order the user performed them in. This continues until sufficient data has been captured to allow accurate predictions to be made.

From the data, pattern key generation is performed and this may be carried out on a different device that has more powerful processing characteristics. The neural net of nodes is processed to identify paths through the nodes which have a high probability of going to a certain destination. A pattern key is created containing the smallest subset of nodes that if the user matches each node in the pattern key, it can be accurately predicted that they will perform the action of the destination node. The process is repeated until all the desired (or possible) pattern keys have been produced, for example where all of the generated pattern keys have the probability of prediction is above a threshold X.

Live pattern key use will then take place when the user's actions are now compared against the nodes in each pattern key being used. If the user's behavior matches the first node in a particular pattern key, the user's subsequent behavior is then compared against the second node for that particular pattern key. All of the pattern keys continue to be monitored. If all the nodes of a particular pattern key are matched, a prediction can be made that the user will perform the action associated with the destination node for that particular pattern key. The user interface 16 is then modified according to some predefined action in relation to the destination mode.

FIG. 4 is an illustration of a schematically diagram having components within a device. FIG. 4 will be discussed in reference to the computer discussed in conjunction with the embodiment of FIG. 2 to provide ease of understanding. The computer, in this embodiment, can be performing an analysis of a user's actions with respect to the user interface 16 of the computer 18. A processor is running a pattern matching engine 22, which maintains a current sequence of events 24. A web browser 26 performs the action labeled (1) in the Figure, which is the detection of a navigation event and the notification of that navigation event to the pattern key matching engine 22. The notified event is then added to the current sequence of events 24, which is being maintained by the engine 22. In this way user's actions are recorded within the engine 22.

The engine 22 has access to a store 28, which comprises the pre-generated pattern keys 10. The engine 22 will perform the action labeled (2) in the Figure, which is the step of checking to see if there is a match between the current sequence of events and any of the pattern keys 10 being stored within the storage device 28. This matching process must find all of the nodes 12 (representing user actions) of a pattern key 10 in the current sequence of events 24 in order to generate a match. The matching process may be configured to only return matches that are in sequence or may also allow matches that are out of sequence. If a match has been detected, then the engine 22 will fire a matching event, which is the action labeled (3) in the Figure. Custom logic 30 within the web browser 30 will receive a message from the engine 22 detailed the existence of the match and providing information relating to the pattern key 10 that has been matched. This will most likely contain detail of the final end node 14 of the relevant pattern key 10. The custom logic 30 will adapt the behavior of the web browser 26 in relation to the anticipated end result 14 of the matched pattern key 10. This might be opening of a new webpage, for example, without waiting for the user's instructions or might be the provision of a shortcut to a new location.

The user of the computer's user interface 16 has their future actions anticipated by the pattern key matching engine 22, which uses the pattern keys 10 stored in the storage device 28. These pattern keys 10 are either global pattern keys 10 that are appropriate for all users or they are user-specific pattern keys 10 that have been generated based upon the navigational history of the user in question. Any predictions made by the pattern matching engine 22 obviously only provide a high percentage likelihood that a user will perform the action associated with the end node 14 of a pattern key as a future action (either immediately or after a small number of other actions), not that the future action by the user is guaranteed.

A predefined action within the user interface 16 is performed after a match has been found by the matching engine 22. The end result 14 of a pattern key 10 may be that a user is now, for example, highly likely to navigate to their personal email to check their inbox. Rather than waiting for the user to perform the user interface steps to carry this out, the user interface may launch the relevant application directly, or may provide an appropriate shortcut to the user so that they can access the application with a single click on a screen location, rather than performing the multiple actions required to gain access to their personal email account.

The user's interaction with the user interface is improved, as they do not have to spend time performing actions that are anticipated by the matching engine 22. FIG. 5 shows an example of a user interface 16 being presented by a display device 32, where a user is presently working on an application represented by a first window 34. A match to a pattern key 10 has been detected and this has resulted in a second window 36 being opened in response to that match, in line with the content of the end node 14 of the specific pattern key 10 that has been matched. The new window 36 is shown as maximized and in view, but could be minimized when loaded to provide a less intrusive change to the user interface 16.

FIG. 6 is an illustration of a flowchart depicting a method summary for the operation of the user interface 16. The method comprises the steps of, firstly step S1, detecting a sequence of actions with respect to the user interface 16, secondly step S2, accessing a database of pattern keys 10, each pattern key 10 defining a sequence of actions 12 with respect to the user interface 16 and a specific end result 14 for the sequence of actions 12, thirdly step S3, matching the detected sequence of actions with respect to the user interface 16 to a pattern key 10 in the database, and finally step S4, performing a predefined action in the user interface 16 in relation to the specific end result of the matched pattern key 10. In this embodiment, low specification devices can take advantage of the database of pattern keys 10, which have been generated in the past from one or many users of the user interface 16. Although significant processing resources are required to generate the pattern keys 10 in the first place, relatively little processing is required to match the pattern keys 10 to the user's actions with respect to the user interface 16. This means the methodology can be used widely in low specification mobile devices and can be embedded within websites for example. The user's actions can be logged and any matching pattern key 10 can be easily identified from the logged actions.

Any match to a pattern key 10 drives a change in the user interface 16, but the nature of that change is not in any way mandated and can be flexible, with different pattern key matches handled in different ways, for example. The essential point is that the user interface 16 is changed so that the user can reach the anticipated destination quicker and/or easier than would otherwise have been possible. This can be achieved by presenting the user with a shortcut or a dedicated part of the user interface 16 could be used to provide a hint or link to the anticipated destination derived from the matched pattern key 10.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Further, as will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of operating a user interface, comprising:
detecting a sequence of actions with respect to the user interface;
accessing a database having a plurality of pattern keys, wherein each of the pattern keys define a sequence of actions with respect to the user interface and a specific end result for the sequence of actions;
matching the detected sequence of actions with respect to the user interface and responsive to one of the pattern keys in the database; and
performing a predefined action in the user interface in relation to the specific end result of a particular pattern key being matched.

2. A method according to claim 1, wherein the step of performing a predefined action in the user interface further comprises presenting a short cut to the specific end result.

3. A method according to claim 1, wherein the step of performing the predefined action in the user interface comprises presenting the specific end result.

4. A method according to claim 1, further comprising identifying a specific user of the user interface.

5. A method according to claim 3, further comprising identifying a specific user of the user interface.

6. A method according to claim 5, wherein the step of matching the detected sequence of actions is specific to an identified user.

7. A device comprising:
a user interface;
a database in processing communication with the user interface;
a processor configured to access the database and the user interface;
the processor enabled to detect a sequence of actions with respect to the user interface and access the database having a plurality of pattern keys;
each of the plurality of the pattern keys defining a sequence of actions with respect to the user interface and a specific end result for the sequence of actions,
the processor matching the detected sequence of actions with respect to the user interface to a specific pattern key in the database, and
the processor performing a predefined action in the user interface in relation to the specific end result of a matched pattern key.

8. A device according to claim 7, wherein the processor is arranged, when performing a predefined action in the user interface, to present a short cut to the specific end result.

9. A device according to claim 7, wherein the processor is arranged, when performing a predefined action in the user interface, to present the specific end result.

10. A device according to claim 7, wherein the processor is further arranged to identify the specific user of the user interface.

11. A device according to claim 10, wherein matching the detected sequence of actions is performed with respect to the user interface in the database.

12. A device according to claim 11, wherein the matching is performed specific to an identified user.

13. A device according to claim 9, wherein the processor is further arranged to identify a specific user.

14. A device according to claim 13, wherein matching the detected sequence of actions is performed with respect to the user interface in the database.

15. A device according to claim 14, wherein the matching is performed specific to an identified user.

16. A computer program product for handling user interfaces, the computer program product comprising a computer readable storage medium having program code embodied therewith, the program code executable by a processor to:
detect a sequence of actions with respect to a particular user interface;
access a database having a plurality of pattern keys, wherein each of the pattern keys define a sequence of actions with respect to the particular user interface and a specific end result for the sequence of actions;
match the detected sequence of actions with respect to the particular user interface and responsive to one of the pattern keys in the database; and
perform a predefined action in the user interface in relation to the specific end result of a matched pattern key.

17. A computer program product according to claim 16, wherein the instructions for performing a predefined action in the user interface comprise instructions for presenting a short cut to the specific end result.

18. A computer program product according to claim 16, wherein the instructions for performing a predefined action in the user interface comprise instructions for presenting the specific end result.

19. A computer program product according to claim 17 further comprising instructions for identifying a specific user.

20. A computer program product according to claim 19, wherein the instructions for matching the detected sequence of actions with respect to the user interface in the database further comprises matching a pattern key specific to the identified specific user.
